(19) United States
(12) Patent Application Publication
(10) Pub. No.: US 2026/0212610 A1
(43) Pub. Date: Jul. 23, 2026

(54) INFORMATION DISPLAY METHOD AND APPARATUS, DEVICE, AND STORAGE MEDIUM

(71) Applicant: GOERTEK INC., Weifang, Shandong (CN)

(72) Inventor: Shuo QU, Weifang, Shandong (CN)

(21) Appl. No.: 18/720,661

(22) PCT Filed: Mar. 31, 2022
(86) PCT No.: PCT/CN2022/084608

§ 371 Date: Jun. 17, 2024

(30) Foreign Application Priority Data
Jan. 27, 2022 (CN) 202210101669.4

(51) Int. Cl. G06T 19/00; G06T 7/50; G06T 7/60; G06T 7/70; G06V 20/20

(52) U.S. Cl. CPC G06T 19/006; G06T 7/50; G06T 7/60; G06T 7/70; G06V 20/20

(57) ABSTRACT

Disclosed are an information display method and apparatus, a device, and a storage medium. The method includes: acquiring pose change information of the device between a first moment and a second moment; using the pose change information and first position information of an identified object stored in a preset storage space at the first moment to determine second position information of the identified object at the second moment; and if the second position information satisfies a preset condition, acquiring object information of the identified object stored in the preset storage space, and sending the object information to a target display area determined on the basis of the second position information in a device display picture for display.

The present disclosure claims the priority to the Chinese Patent Application No. 202210101669.4, entitled “INFORMATION DISPLAY METHOD AND APPARATUS DEVICE, AND STORAGE MEDIUM”, filed with China Patent Office on Jan. 27, 2022, the entire contents of which are incorporated into the present disclosure by reference.

### TECHNICAL FIELD

The present disclosure relates to a technical field of smart devices, and, specifically, to an information display method and apparatus, a device, and a storage medium.

### Description of Related Art

In recent years, with the rapid development of smart wearable devices, smart devices that can superimpose virtual information with real scenes to display them have gradually entered people's daily life and work. These devices integrate sensing technology, 3D modeling, optical display, etc., can simulate computer-generated text, images, audio, and video information, and then apply and display them in the real world as a supplement to real-world information. Devices such as Augmented Reality (AR) and Mixed Reality (MR) can achieve the effect of integrating virtual information with the real world.

Currently, the above-mentioned smart devices extract feature points of a target object in the field of view image and match the feature points, thereby identifying target object information and a target display area in the field of view image for displaying the above-mentioned target object information, so as to display the above-mentioned target object information in the above-mentioned target display area. After the current image is recognized, if the smart device moves next, the position of the target object relative to the field of view image will also shift accordingly. At this time, it is necessary to identify the target object information in the current field of view image and its corresponding target display area by re-extracting feature points and matching the feature points. However, extracting and matching the feature points of the target object is a very time-consuming operation, which may cause a significant delay in the display process of the object information in the field of view image.

### SUMMARY

In view of the above, a purpose of the present disclosure is to provide an information display method and apparatus, a device, and a storage medium, which can effectively reduce the display delay of object information in a field of view image. The specific technical solution is as follows.

In a first aspect, the present disclosure provides an information display method, which is applied to a device configured to display by superimposing virtual information with a real scene, including:
acquiring pose change information of the device between a first moment and a second moment;
determining second position information of the identified object at the second moment by using the pose change information and first position information of an identified object at the first moment stored in a preset storage space; and
if the second position information satisfies a preset condition, acquiring object information of the identified object stored in the preset storage space, and sending the object information to a target display area determined based on the second position information in a device display image for display.

Optionally, the information display method further includes:
acquiring a real scene image at any time;
sending the real scene image to a preset image recognition platform to identify object information in the real scene image and detect position information of scene object in the real scene image by the image recognition platform, so as to obtain a corresponding image recognition result; and
saving the image recognition result returned by the image recognition platform in the preset storage space.

Optionally, identifying object information in the real scene image by the image recognition platform includes:
identifying object type of the scene object in the real scene image by using an image recognition model pre-constructed based on artificial intelligence algorithm in the image recognition platform, and searching for specific description information corresponding to the scene object from a preset information base based on the object type.

Optionally, detecting position information of scene object in the real scene image by the image recognition platform includes:
detecting image area size information of the scene object in the real scene image as well as two-dimensional coordinate information of the scene object in an image coordinate system corresponding to the real scene image by the image recognition platform.

Optionally, acquiring a real scene image at any time includes:
acquiring a real scene image and image depth information at any time.

Accordingly, sending the real scene image to a preset image recognition platform to identify object information in the real scene image and detect position information of scene object in the real scene image by the image recognition platform includes:
sending the real scene image and the image depth information to the preset image recognition platform to detect image area size information of the scene object in the real scene image as well as two-dimensional coordinate information of the scene object in an image coordinate system corresponding to the real scene image by the image recognition platform, and mapping the two-dimensional coordinate information to a camera coordinate system based on the image depth information to obtain three-dimensional coordinate information of the scene object in the camera coordinate system.

Optionally, saving the image recognition result returned by the image recognition platform in the preset storage space includes:
comparing the object information in the image recognition result with object information currently stored in the preset storage space so as to extract object information of a target static object that is not currently stored in the preset storage space from the image recognition result; and
saving the object information of the target static object in the image recognition result and corresponding position information in the preset storage space.

Optionally, the method further includes: after determining second position information of the identified object at the second moment, updating the first position information in the preset storage space using the second position information.

Optionally, if the second position information satisfies a preset condition, acquiring object information of the identified object stored in the preset storage space, and sending the object information to a target display area determined based on the second position information in a device display image for display, includes:
determining an image area corresponding to the identified object in the device display image based on the second position information, and determining a first ratio between an object size corresponding to the image area and a full size of the identified object;
if the first ratio is not less than a first preset threshold, determining a second ratio between an area of the image area and an entire image area of the device display image; and
if the second ratio is less than a second preset threshold, sending the object information of the identified object stored in the preset storage space to a target display area determined based on the image area in the device display image for display.

Optionally, sending the object information of the identified object stored in the preset storage space to a target display area determined based on the image area in the device display image for display includes:
determining a target display area having a fixed relative position relationship with the image area on the device display image, and sending the object information of the identified object stored in the preset storage space to the target display area for display.

In a second aspect, the present disclosure provides information display apparatus, which is applied to a device configured to display by superimposing virtual information with a real scene, including:
a pose acquisition module configured to acquire pose change information of the device between a first moment and a second moment;
a position determination module configured to determine second position information of the identified object at the second moment by using the pose change information and first position information of an identified object at the first moment stored in a preset storage space; and
an information display module configured to, if the second position information satisfies a preset condition, acquire object information of the identified object stored in the preset storage space, and send the object information to a target display area determined based on the second position information in a device display image for display.

In a third aspect, the present disclosure provides an electronic device, including:
a memory for storing a computer program; and
a processor for executing the computer program to implement steps of the aforementioned information display method.

In a fourth aspect, the present disclosure provides a computer-readable storage medium for storing a computer program, wherein when the computer program is executed by a processor, steps of the aforementioned information display method are implemented.

In the present disclosure, the first position information of the identified object at the first moment and the object information corresponding to the identified object are pre-saved in the preset storage space; when pose change information of the device between a first moment and a second moment is acquired, the pose change information and the position information of an identified object stored in a preset storage space at the first moment are used to determine position information of the identified object at the second moment; and if the position information of the identified object at the second moment satisfies a preset condition, the object information of the identified object stored in the preset storage space is sent to a target display area determined based on the second position information in a device display image for display. It can be seen that in the present disclosure, when displaying the object information in the device display image at the current moment, a second position information of the identified object at the current moment may be firstly determined based on the first position information of the identified object at a previous moment and pose change information of the device between the two moments; and if the second position information meets the preset condition, a corresponding target display area may be determined based on the second position information, and the object information of the identified object can be directly obtained from the preset storage space and be displayed in the target display area, thereby avoiding the need to re-extract and match feature points to obtain the object information and the corresponding target display area, which reduces the time consumption caused by feature point extraction and matching, and effectively reduces the display delay of the object information in a field of view image, and therefore increases the display speed of the object information in the field of view image.

### BRIEF DESCRIPTION OF DRAWINGS

In order to more clearly illustrate the embodiments of the present disclosure or the technical solutions in the prior art, the drawings required to be used for the content of the embodiments or the prior art will be briefly introduced in the following. Obviously, the drawings in the following description are merely a part of the drawings of the present disclosure, and for those of ordinary skill in the art, other drawings can also be obtained from the provided drawings without any creative effort.

FIG. 1 is a flow chart of an information display method according to the present disclosure;

FIG. 2 is a flow chart of image recognition according to the present disclosure;

FIG. 3 is a flow chart of a specific information display method according to the present disclosure;

FIGS. 4 to 9 are schematic diagrams respectively displaying object information in different circumstances;

FIG. 10 is a time chart of an information display method according to the present disclosure;

FIG. 11 is a schematic structural diagram of information display apparatus according to the present disclosure; and

FIG. 12 is a structural diagram of an electronic device according to the present disclosure.

### DETAILED DESCRIPTIONS

Technical solutions of embodiments of the present disclosure will be clearly and completely described below with reference to the drawings in the embodiments of the present disclosure. Obviously, the described embodiments are only a part of the embodiments of the present disclosure, rather than all the embodiments. Based on the embodiments in the present disclosure, all other embodiments obtained by those of ordinary skill in the art without creative efforts shall fall within the protection scope of the present disclosure.

In recent years, with rapid development of smart wearable devices, smart devices that can superimpose virtual information with real scenes have gradually entered people's daily life and work. After the above-mentioned smart device recognizes the current image, if the smart device moves next, the position of the target object relative to the field of view image will also shift accordingly. At this time, it is necessary to identify the target object information in the current field of view image and its corresponding target display area by re-extracting feature points and matching the feature points. However, extracting and matching the feature points of the target object is a very time-consuming operation, which may cause a significant delay in the display process of the object information in the field of view image.

To this end, the present disclosure provides an information display solution that can effectively reduce the display delay of object information in a field of view image. The information display solution is specifically applied to a device that can superimpose virtual information with real scenes for display, and the device includes but is not limited to an augmented reality device, a mixed reality device, etc.

In the present disclosure, the above-mentioned device captures a real scene image through a camera module thereof, and sends the captured real scene image to a preset image recognition platform through a communication interface thereof, so as to identify object information in the real scene image and detect position information of scene object in the real scene image through the image recognition platform, to obtain a corresponding image recognition result. It should be pointed out that the above-mentioned image recognition platform generally refers to an image recognition platform located in a cloud server with good computing capability, so as to utilize the strong computing capability of the cloud server to improve the recognition speed of real scene images. Of course, the present disclosure does not exclude the possibility of utilizing an image recognition component integrated in the above-mentioned device or utilizing an image recognition component integrated in a computer that is connected to the above-mentioned device for short-range communication to perform image recognition on real scene images. Although the computing capability of the above-mentioned device or the above-mentioned computer itself is not as good as that of the cloud server, they can save a certain amount of time in communication transmission because of unnecessity of remote communication requests and remote communication responses.

After the image recognition platform obtains the image recognition result containing the corresponding object information and position information, it returns the image recognition result to the device through a corresponding Application Programming Interface (API), So that the device sends the received image recognition result to a preset storage space for storage. This means that the object information and position information stored in the preset storage space are the object information and position information of the identified object. In addition, it should be pointed out that the preset storage space generally refers to a storage space integrated inside the device, so that whenever it is necessary to obtain data stored in the preset storage space, corresponding data can be directly read from the device locally, which effectively reduces the data acquisition time. Of course, the preset storage space may also refer to a storage space in a computer connected to the device for short-range communication, and whenever it is necessary to obtain data stored in the preset storage space, the corresponding data can be obtained from the computer through short-range data access.

When the user uses the above-mentioned device, the device detects pose change information of the device between the current moment and the previous moment through a pose detection component integrated therein. The pose detection component may perform pose detection based on Inertial Measurement Unit (IMU) data integration. Of course, the pose detection may be performed by using a Simultaneous Localization and Mapping (SLAM) pose estimation technology based on structured light and IMU or a Time of Flight (TOF) technology, and the pose detection method is not specifically limited herein.

After detecting the pose change information between the current moment and the previous moment, the device acquires position information of the identified object at the previous moment pre-saved in the preset storage space, and then calculates position information of the identified object at the current moment through a processor thereof using the pose change information and the position information of the identified object at the previous moment saved in the preset storage space, and when the position information meets a preset condition, a target display area is determined from the device display image based on the position information, and then the object information of the identified object saved in the preset storage space is sent to the target display area for display. According to the technical solution, the present disclosure can reduce the time consumption caused by feature point extraction and matching, and effectively reduce the display delay of the object information in a field of view image, thereby increasing the display speed of the object information in the field of view image.

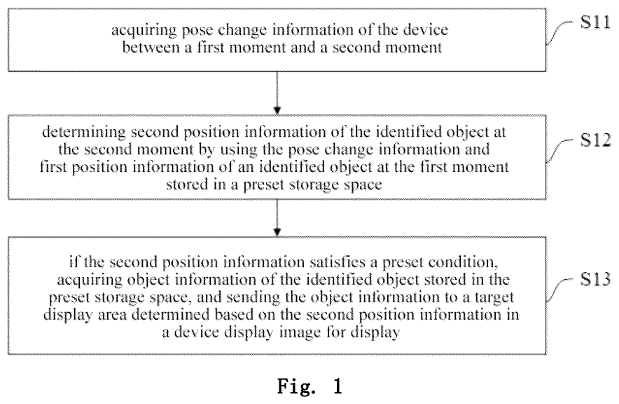

Specifically, as illustrated in FIG. 1, an embodiment of the present disclosure discloses an information display method, which is applied to a device configured to display by superimposing virtual information with a real scene. The method includes:

S11: acquiring pose change information of the device between a first moment and a second moment.

It will be understood that during the use of the device, the position and pose of the device will change due to the movement of the user. At this time, the pose detection component integrated inside the device can acquire pose change information of the device between the first moment and the second moment, including turning angle degree and displacement distance of the device between the two moments.

In the embodiment, the first moment and the second moment generally refer to two adjacent moments. Of course, in some scenarios, the first moment and the second moment may be separated by a number of moments. In addition, in the embodiment, a time interval between any two adjacent moments can be determined based on actual situations during the application process. For example, in the embodiment, a time interval between any two adjacent moments can be determined based on pose information sampling frequency of the pose detection component, or based on display frame rate of the device display image, and it is not specifically limited herein.

S12: determining second position information of the identified object at the second moment by using the pose change information and first position information of an identified object at the first moment stored in a preset storage space.

In the embodiment, the first position information of the identified object at the first moment is stored in advance in the preset storage space. When the pose change information of the device between the first moment and the second moment is acquired, the first position information of the identified object at the first moment is searched from the preset storage space using corresponding time index information, and then second position information of the identified object at the second moment is calculated using the pose change information and the first position information. In the embodiment, the above-mentioned time index information may be constructed based on timestamp information corresponding to the first moment, so that the first position information of the identified object corresponding to the first moment can be retrieved from the preset storage space through the time index information.

It should be pointed out that in the embodiment, after determining the second position information of the identified object at the second moment, the second position information may be further used to update the first position information in the preset storage space, that is, replace the first position information corresponding to the first moment stored in the preset storage space with the second position information corresponding to the second moment. Likewise, the first position information of the identified object at the first moment originally stored in the preset storage space may also be position information of the identified object at the first moment calculated by using the pose change information between the first moment and the previous moment and the position information of the identified object at the previous moment stored in the preset storage space. Of course, the first position information may also be position information obtained by performing image recognition on a real scene image collected at the first moment by a dedicated image recognition platform.

S13: if the second position information satisfies a preset condition, acquiring object information of the identified object stored in the preset storage space, and sending the object information to a target display area determined based on the second position information in a device display image for display.

In the embodiment, the second position information needs to meet a preset condition to obtain the object information of the identified object stored in the preset storage space and send it to a target display area determined based on the second position information in a device display image for display. It will be understood that the preset condition needs to include at least one condition, that is, after the second position information is projected to an image coordinate system where the device display image is located, the image area coordinates corresponding to the second position information cannot be completely outside the device display image, and otherwise it is prohibited to obtain the object information of the identified object from the preset storage space and display it.

In the embodiment, the object information stored in the preset storage space is object information obtained by identifying the scene object in the real scene image. Typically, after object information of a scene object is identified for the first time, it is saved in a preset storage space, and there is usually no need to save the object information of the same scene object identified in other real scene images in the preset storage space. However, it is considered that specific description information of the same scene object, such as price information of an item, may undergo obvious changes at different times. In these cases, in order to avoid the problem of outdated object information displayed on the device display image, it is necessary to determine whether the specific description information in the currently recognized object information is consistent with the specific description information of the same scene object previously saved in the preset storage space when the object information of the same scene object is recognized in the current real scene image. If they are consistent, the object information of the currently recognized scene object will be discarded and not saved. If they are inconsistent, the currently recognized object information of the scene object will be used to replace and update the object information of the same scene object saved in the preset storage space.

In the embodiment, the preset storage space can bind and store the position information of the identified object and the object information of the identified object. After using the time index information to search the first position information of the identified object at the first moment from the preset storage space, if the calculated second position information also meets the preset condition, object information that is bound with the first position information can be searched from the preset storage space, and the target display area can be determined from the device display image based on the second position information, and then found object information is sent to the target display area for display.

It can be seen that in the present embodiment, when displaying the object information in the device display image at the current moment, a second position information of the identified object at the current moment may be firstly determined based on the first position information of the identified object at a previous moment and pose change information of the device between the two moments; and if the second position information meets the preset condition, a corresponding target display area may be determined based on the second position information, and the object information of the identified object can be directly obtained from the preset storage space and be displayed in the target display area, thereby avoiding the need to re-extract and match feature points to obtain the object information and the corresponding target display area, which reduces the time consumption caused by feature point extraction and matching, and effectively reduces the display delay of the object information in a field of view image, and therefore increases the display speed of the object information in the field of view image.

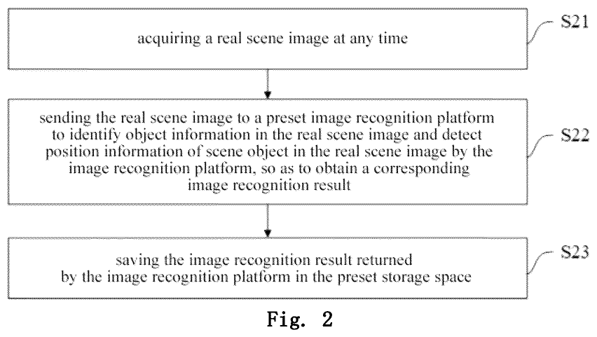

Based on the previous embodiment, it can be known that in the present disclosure, object information and position information in the preset storage space can be obtained by identifying a real scene image. To this end, an image recognition process of the real scene image will be described in detail below in the embodiment. As illustrated in FIG. 2, the present embodiment discloses an image recognition process including:

S21: acquiring a real scene image at any time;

S22: sending the real scene image to a preset image recognition platform to identify object information in the real scene image and detect position information of scene object in the real scene image by the image recognition platform, so as to obtain a corresponding image recognition result; and

S23: saving the image recognition result returned by the image recognition platform in the preset storage space.

In the embodiment, the device can capture images of the real scene through a camera module thereof to obtain the above-mentioned real scene image.

In a specific implementation, the camera module is a common camera module for capturing two-dimensional images. In the embodiment, a two-dimensional real scene image captured by the camera module at any time is sent to a preset image recognition platform, so as to identify the object type of the scene object in the real scene image by using an image recognition model pre-constructed based on the artificial intelligence algorithm in the image recognition platform, and search for specific description information corresponding to the scene object from a preset information base based on the object type and detect image area size information of the scene object in the real scene image and two-dimensional coordinate information of the scene object in an image coordinate system corresponding to the real scene image through the image recognition platform. That is, in the embodiment, the object information obtained by identification through the image recognition platform may include object type of the scene object and specific description information, and the position information obtained by detection through the image recognition platform may include image area size information of the scene object in a real scene image and two-dimensional coordinate information in an image coordinate system corresponding to the real scene image. The image area size information may include image area width and image area height corresponding to the scene object, the two-dimensional coordinate information includes a distance from an upper left corner of the image area corresponding to the scene object to a vertical axis and a distance from the upper left corner to a horizontal axis.

Corresponding to the above implementation, when calculating the position information of the target scene object at the current moment by using the current pose change information of the device and the position information of the target scene object at the previous moment in the preset storage space, a specific process may include transforming the image area size information and two-dimensional coordinate information at the previous moment stored in the preset storage space based on the pose change information, so as to obtain the transformed image area size information and the transformed two-dimensional coordinate information, that is, to obtain the position information of the target scene object at the current moment.

In addition, in the embodiment, the preset information base is specifically used to collect the latest specific description information corresponding to various scene objects. Each time the image recognition platform is used to identify the received real scene image, the current latest specific description information corresponding to the scene object can be searched from the preset information base, and compared with the specific description information of the scene object currently stored in the preset storage space. If the two are found to be inconsistent, the specific description information searched from the preset information base can be used to replace and update the specific description information in the preset storage space. It will be understood that the preset information base may be an information base pre-integrated in a third-party server, which can dynamically collect the latest specific description information corresponding to various scene objects.

In another specific implementation, the camera module refers to a camera module including a depth sensor. In the present embodiment, two-dimensional real scene image and image depth information at any time are collected by the camera module, and the real scene image and image depth information are sent to a preset image recognition platform, so as to identify the object type of the scene object in the real scene image by using an image recognition model pre-constructed based on the artificial intelligence algorithm in the image recognition platform, and search for specific description information corresponding to the scene object from a preset information base based on the object type and detect image area size information of the scene object in the real scene image and two-dimensional coordinate information of the scene object in an image coordinate system corresponding to the real scene image through the image recognition platform, and then the two-dimensional coordinate information is mapped to a camera coordinate system based on the image depth information to obtain three-dimensional coordinate information of the scene object in the camera coordinate system. The image area size information may include image area width and image area height corresponding to the scene object.

Corresponding to the above implementation, when calculating the position information of the target scene object at the current moment by using the current pose change information of the device and the position information of the target scene object at the previous moment in the preset storage space, a specific process may include transforming the image area size information and three-dimensional coordinate information at the previous moment stored in the preset storage space based on the pose change information, so as to obtain the transformed image area size information and the transformed three-dimensional coordinate information, that is, to obtain the position information of the target scene object at the current moment.

In the embodiment, saving the image recognition result returned by the image recognition platform in the preset storage space may specifically include: comparing the object information in the image recognition result with the object information currently stored in the preset storage space to extract object information of target static object that is not currently stored in the preset storage space from the image recognition result; saving the object information of the target static object in the image recognition result and corresponding position information in the preset storage space. In the embodiment, in order to improve the efficiency of information comparison, various data information can be saved in the preset storage space in the form of a list, and corresponding keyword index information constructed based on object information, such as object type keywords, etc., can be added thereto. Accordingly, after obtaining the object information in the image recognition result, the object information in the image recognition result and the object information currently stored in the preset storage space are compared by using the keyword index information to extract the object information of the target static object that is not currently stored in the preset storage space from the image recognition result.

In the embodiment, when the device finds that the image recognition result of the real scene image at any moment returned by the image recognition platform includes object information and position information of a new object, the object information of the new object can be sent to an upper area of the device display image relative to the image area where the new object is located for display. It will be understood that there is a certain time delay in the process from capturing the real scene image of a new object to sending the object information of the new object to the device display image for display. For example, a corresponding real scene image with a new object is captured at time T2, but the object information of the new object cannot be displayed at time T2; instead, it needs to be sent to the image recognition platform for image recognition and the image recognition result needs to be returned to a device processor for information comparison and analysis to determine whether there is a new object in the scene at time T2, and corresponding object information of the new object is transmitted to the screen for display. The time delay required for this entire process is A, which means that a corresponding time when the object information of the new object is displayed on the image is T2+Δ.

It will be understood that in the embodiment, by comparing the object information in the image recognition result with the object information stored in the preset storage space, it can be determined whether corresponding scene objects are the same object, if they are the same object, it can be further determined whether the scene object is a static object, and if it is a static object, object information of the static object in the image recognition result and corresponding position information are saved in the preset storage space.

Furthermore, in the present embodiment, in order to determine whether the target scene object in the real scene image is a static object, a unified analysis may be performed on multiple real scene images collected at several moments in the past to detect whether relative position of the target scene object in these real scene images relative to a reference object with a fixed position in the scene has changed. If it has changed, it is determined that the target scene object is a dynamic object; if it has not changed, it is determined that the target scene object is a static object.

It should be noted that if the target scene object in the real scene image is not a static object but a dynamic object, it is necessary to use a depth sensor on the device to detect pose change information of the target scene object between the first moment and the second moment, and determine second position information of the target scene object at the second moment based on the pose change information of the device, the position change of object and the first position information of the target scene object at the first moment stored in the preset storage space.

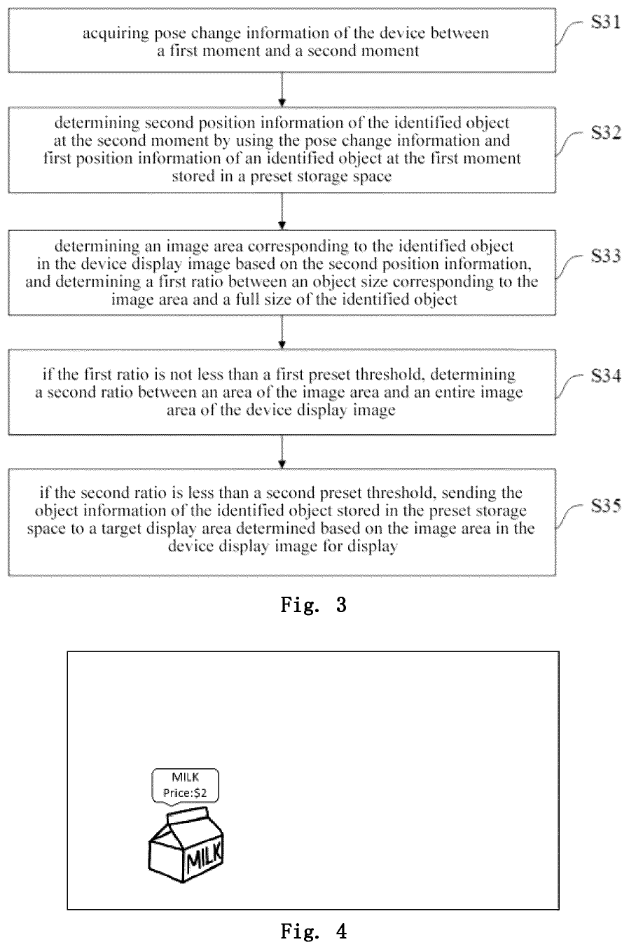

As illustrated in FIG. 3, the embodiment of the present disclosure discloses a specific information display method, including:

S31: acquiring pose change information of the device between a first moment and a second moment.

S32: determining second position information of the identified object at the second moment by using the pose change information and first position information of an identified object at the first moment stored in a preset storage space.

S33: determining an image area corresponding to the identified object in the device display image based on the second position information, and determining a first ratio between an object size corresponding to the image area and a full size of the identified object.

In the embodiment, the second position information includes image area size information of the identified object in the real scene image and corresponding coordinate information, wherein the coordinate information may be two-dimensional coordinate information of the identified object in an image coordinate system corresponding to the real scene image, or three-dimensional coordinate information of the identified object in a camera coordinate system.

S34: if the first ratio is not less than a first preset threshold, determining a second ratio between an area of the image area and an entire image area of the device display image.

In the embodiment, if the ratio between an object size corresponding to the image area of the identified object in the device display image and a full size of the object is less than the first preset threshold, it indicates that most or all of the area corresponding to the current identified object has already been outside the device display image. At this time, it is not suitable to send the object information of the identified object stored in the preset storage space to the device display image for display, which is conducive to improving the user experience. If the ratio between an object size corresponding to the image area of the identified object in the device display image and a full size of the object is not less than the first preset threshold, it indicates that most of the area of the identified object is located within the device display image. At this time, it is necessary to further determine a second ratio between an area of the image area and an entire image area of the device display image.

S35: if the second ratio is less than a second preset threshold, sending the object information of the identified object stored in the preset storage space to a target display area determined based on the image area in the device display image for display.

In the embodiment, if the second ratio is greater than or equal to the second preset threshold, it indicates that the image area corresponding to the current identified object covers most of the proportion of the entire device display image, and at this time, it is not suitable to send the object information of the identified object stored in the preset storage space to the device display image for display. If the second ratio is less than the second preset threshold, the object information of the identified object stored in the preset storage space is sent to a target display area determined based on the image area in the device display image for display.

It should be noted that the first preset threshold and the second preset threshold may be set differently based on actual scenario requirements. For example, the first preset threshold may be set to 30%, and the second preset threshold may be set to 70%.

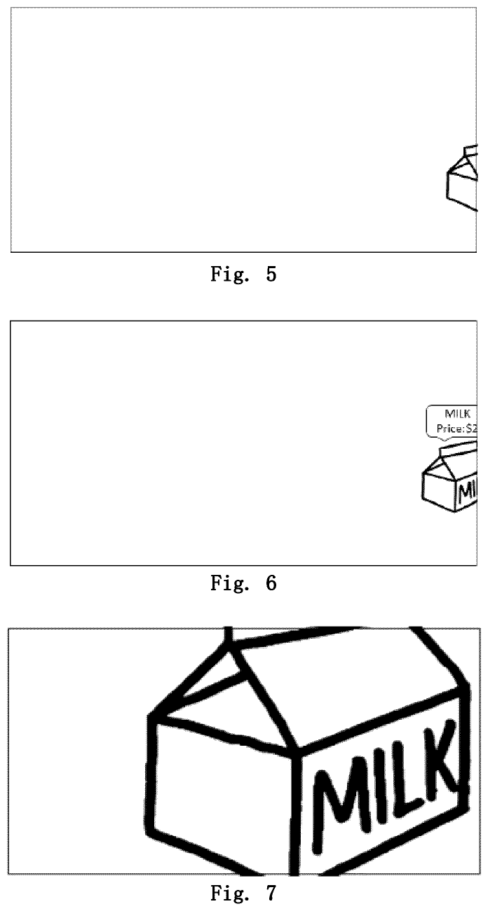

In the present embodiment, object information in different circumstances is shown respectively in FIGS. 4-9.

As illustrated in FIG. 4, assuming that at time T1, there is a box of milk in the real scene, and the product type, price information and corresponding position information of the box of milk have been obtained in advance, the product type MILK and price tag information $2 may be displayed in an upper area of the box of milk based on the position information of the box of milk.

As illustrated in FIG. 5, assuming that after time T1, only a small portion of the area of the box of milk remains on the device display image, the price tag information may not be displayed at this time.

As illustrated in FIG. 6, assuming that after time T1, a small part of the box of milk has been moved out of the device display image, but most of the box of milk still remains within the device display image, the object type MILK and the price tag information $2 may still remain being displayed at this time.

As illustrated in FIG. 7, assuming that after time T, most of the area of the box of milk remains on the device display image, it is chosen not to display its price tag information at this time though most of the area of the box of milk remains on the device display image, since its corresponding image area covers most of the entire device display image.

As illustrated in FIG. 8, assuming that at time T2, a new cup appears in the real scene, since the relevant information of the cup has not been obtained at this time, the object information of the cup cannot be displayed at time T2; instead, it is necessary to send it to the image recognition platform for image recognition and an image recognition result needs to be returned to the device for information comparison and analysis to determine that there is a new object, i.e. a cup, in the scene at time T2, and the product type and price tag information of the cup are transmitted to the image for display. The time delay required for the entire process is Δ, which means that a corresponding time when the object information of the cup is displayed on the image is T2+Δ, as shown in FIG. 9.

In the embodiment, sending the object information of the identified object stored in the preset storage space to a target display area determined based on the image area in the device display image for display may specifically include: determining a target display area having a fixed relative position relationship with the image area on the device display image, and sending the object information of the identified object stored in the preset storage space to the target display area for display. In the embodiment, there is a fixed relative position relationship between the target display area and the image area. For example, the target display area may refer to a display area directly above the image area, or may refer to a display area on the left side of the image area, etc., and the fixed relative position relationship is not specifically limited herein.

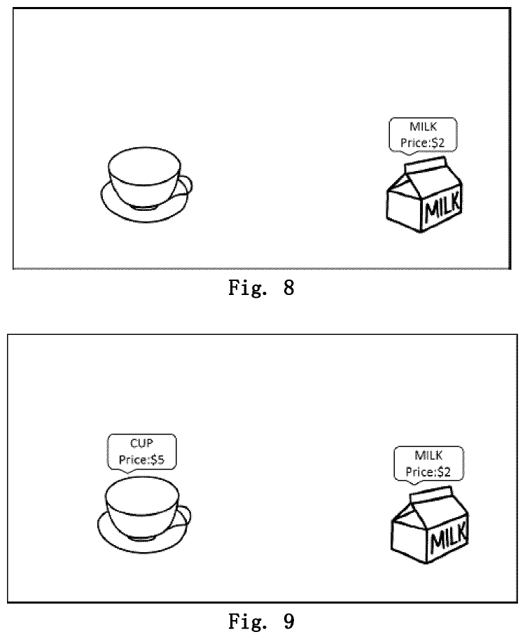

The technical solution of the embodiment of the present disclosure is described in detail below in conjunction with a time chart disclosed in FIG. 10.

In the present embodiment, the device configured to display by superimposing virtual information with a real scene is an AR wearable device, which is used for a cloud server integrated with an image recognition platform for image recognition. In the AR wearable device, a communication interface, a camera module (not shown in the drawings), a pose detection component (not shown in the drawings), a preset storage space and a display module are integrated.

Firstly, the AR wearable device captures a real scene image of a new object A appearing at time T1 through the camera module, and sends the real scene image at time T1 to the cloud server through the communication interface thereof, so that the object information in the real scene image at time T1 can be identified through the image recognition platform in the cloud server, and the position information of the scene object in the real scene image at time T1 can be detected, so as to obtain a corresponding first image recognition result.

The AR wearable device acquires the first image recognition result returned by the cloud server, extracts the object information and first position information of object A from the first image recognition result through a processor, and saves the object information and the first position information of object A in the preset storage space.

When time T2 arrives, the AR wearable device detects the pose change information between time T1 and time T2 through a pose detection component, and captures a real scene image of a new object B appearing at time T2 through the camera module, and then sends the real scene image at time T2 to the cloud server through the communication interface, so that the object information in the real scene image at time T2 can be identified through the image recognition platform in the cloud server, and the position information of the scene object in the real scene image at time T2 can be detected, so as to obtain a corresponding second image recognition result.

The AR wearable device acquires the first position information of object A at time T1 from the preset storage space, and uses the pose change information of the device between time T1 and time T2 and the first position information to determine the second position information of object A at time T2, and determines whether the second position information meets a preset condition constructed based on a proportional size of object A outside the edge of the image and an area size ratio of object A in the image. If so, the object information of object A saved in the preset storage space is obtained and sent to the upper area of object A in the device display image for display.

The AR wearable device obtains the second image recognition result returned by the cloud server, and compares the second image recognition result with the information saved in the current preset storage space. When it is determined that object B in the second image recognition result is a new object in the scene, the object information and position information of object B are saved to the preset storage space.

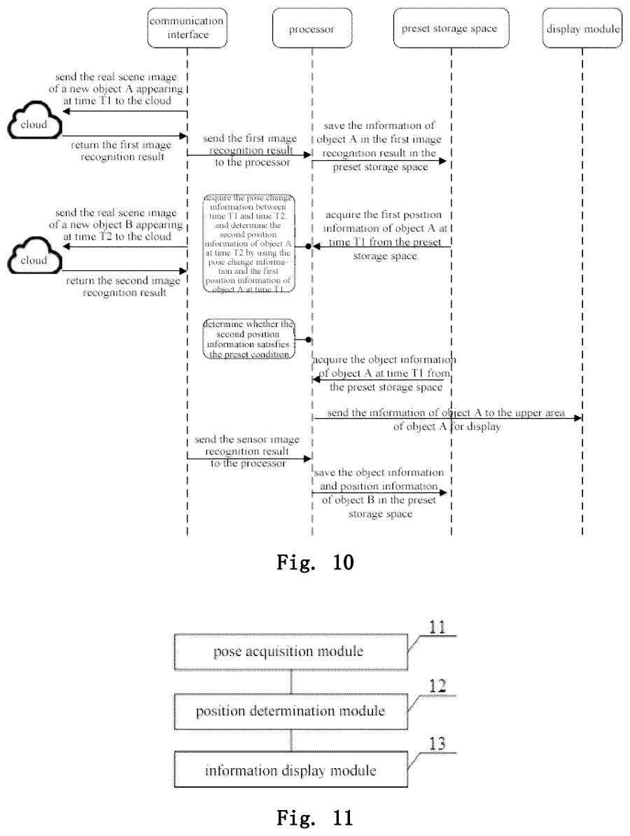

Further, as illustrated in FIG. 11, an embodiment of the present disclosure discloses an information display device, which is applied to a device configured to display by superimposing virtual information with a real scene, including:
a pose acquisition module 11 configured to acquire pose change information of the device between a first moment and a second moment;
a position determination module 12 configured to determine second position information of the identified object at the second moment by using the pose change information and first position information of an identified object at the first moment stored in a preset storage space; and
an information display module 13 configured to, if the second position information satisfies a preset condition, acquire object information of the identified object stored in the preset storage space, and send the object information to a target display area determined based on the second position information in a device display image for display.

For more specific operation processes of the above-mentioned modules, please refer to the corresponding contents disclosed in the aforementioned embodiments, which will not be repeated here.

It can be seen that in the present disclosure, when displaying the object information in the device display image at the current moment, a second position information of the identified object at the current moment may be firstly determined based on the first position information of the identified object at a previous moment and pose change information of the device between the two moments; and if the second position information meets the preset condition, a corresponding target display area may be determined based on the second position information, and the object information of the identified object can be directly obtained from the preset storage space and be displayed in the target display area, thereby avoiding the need to re-extract and match feature points to obtain the object information and the corresponding target display area, which reduces the time consumption caused by feature point extraction and matching, and effectively reduces the display delay of the object information in a field of view image, and therefore increases the display speed of the object information in the field of view image.

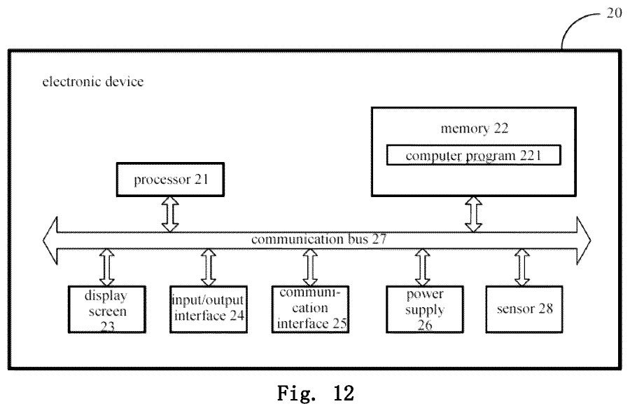

Further, an embodiment of the present disclosure discloses an electronic device. FIG. 12 is a structural diagram of an electronic device 20 according to an exemplary embodiment, and the content in the diagram shall not be considered as any limitation on the scope of use of the present disclosure.

FIG. 12 is a structure diagram of an electronic device 20 according to an embodiment of the present disclosure. The electronic device 20 may specifically include: at least one processor 21, at least one memory 22, a display screen 23, an input/output interface 24, a communication interface 25, a power supply 26, a communication bus 27, and a sensor 28. Here, the memory 22 is used to store a computer program, and the computer program is loaded and executed by the processor 21 to implement the relevant steps in the information display method disclosed in any of the aforementioned embodiments. In addition, the electronic device 20 in the embodiment may specifically be an electronic computer.

In the embodiment, the power supply 26 is configured to provide operation voltage for each hardware device on the electronic device 20; the communication interface 25 can provide a data transmission channel between the electronic device 20 and an external device, and the communication protocol it follows is any communication protocol that can be applied to the technical solution of the present disclosure, and is not specifically limited here; the input/output interface 24 is used to obtain external input data or output data to the external device, and its specific interface type can be selected according to specific application needs and is not specifically limited here; the sensor 28 is configured to detect information about surrounding environment, and includes, but is not limited to, a depth sensor, an inertial measurement unit, etc.

In addition, the memory 22, as a carrier for storing resources, may be a read-only memory, a random access memory, a disk or an optical disk, etc. The resources stored thereon may include a computer program 221, and the storage method may be temporary storage or permanent storage. Here, the computer program 221 may include, in addition to a computer program capable of being used to complete the information display method performed by the electronic device 20 disclosed in any of the aforementioned embodiments, a computer program capable of being used to complete other specific tasks.

Further, an embodiment of the present disclosure also discloses a computer-readable storage medium for storing a computer program; wherein, when the computer program is executed by a processor, the aforementioned disclosed information display method is implemented.

Finally, it should be noted that relational terms such as first and second described herein are only used to distinguish one entity or operation from another entity or operation, and do not necessarily require or imply any such actual relationship or order between these entities or operations. Moreover, terms such as “comprise”, “include” or any other variation thereof are intended to encompass a non-exclusive inclusion such that a process, method, article or apparatus that includes a series of elements includes not only those elements, but also other elements not explicitly listed, or elements inherent to such a process, method, article or apparatus. Without further limitation, the element defined by the phrase “comprising a . . . ” does not preclude the presence of additional identical elements in the process, method, article or apparatus including the element.

The above is a detailed introduction to an information display method and apparatus, device, and a storage medium according to the present disclosure. Specific examples are used herein to illustrate the principles and implementations of the present disclosure. The description of the above embodiments is only used to help understand the method of the present disclosure and its core idea; at the same time, for those skilled in the art, modifications in specific implementations and application scopes are possible according to the idea of the present disclosure. In summary, the content of this specification should not be understood as a limitation on the present disclosure.

1. An information display method, which is applied to a device configured to display by superimposing virtual information with a real scene, comprising:
acquiring pose change information of the device between a first moment and a second moment;
determining second position information of the identified object at the second moment by using the pose change information and first position information of an identified object at the first moment stored in a preset storage space; and
if the second position information satisfies a preset condition, acquiring object information of the identified object stored in the preset storage space, and sending the object information to a target display area determined based on the second position information in a device display image for display.

2. The information display method of claim 1, further comprising:
acquiring a real scene image at any time;
sending the real scene image to a preset image recognition platform to identify object information in the real scene image and detect position information of a scene object in the real scene image by the image recognition platform, so as to obtain a corresponding image recognition result; and
saving the image recognition result returned by the image recognition platform in the preset storage space.

3. The information display method of claim 2, wherein identifying object information in the real scene image by the image recognition platform comprises:
identifying object type of the scene object in the real scene image by using an image recognition model pre-constructed based on artificial intelligence algorithm in the image recognition platform, and searching for specific description information corresponding to the scene object from a preset information base based on the object type.

4. The information display method of claim 2, wherein detecting position information of the scene object in the real scene image by the image recognition platform comprises:
detecting, by the image recognition platform, image area size information of the scene object in the real scene image as well as two-dimensional coordinate information of the scene object in an image coordinate system corresponding to the real scene image.

5. The information display method of claim 2, wherein the acquiring a real scene image at any time comprises:
acquiring a real scene image and image depth information at any time; and
wherein, the sending the real scene image to a preset image recognition platform to identify object information in the real scene image and detect position information of the scene object in the real scene image by the image recognition platform comprises:
sending the real scene image and the image depth information to the preset image recognition platform to detect, by the image recognition platform, image area size information of the scene object in the real scene image as well as two-dimensional coordinate information of the scene object in an image coordinate system corresponding to the real scene image, and mapping the two-dimensional coordinate information to a camera coordinate system based on the image depth information to obtain three-dimensional coordinate information of the scene object in the camera coordinate system.

6. The information display method of claim 2, wherein the saving the image recognition result returned by the image recognition platform in the preset storage space comprises:
comparing the object information in the image recognition result with object information currently stored in the preset storage space so as to extract object information of a target static object that is not currently stored in the preset storage space from the image recognition result; and
saving the object information of the target static object in the image recognition result and corresponding position information in the preset storage space.

7. The information display method of claim 1, further comprising: after the determining second position information of the identified object at the second moment, updating the first position information in the preset storage space using the second position information.

8. The information display method of claim 1, wherein if the second position information satisfies a preset condition, the acquiring object information of the identified object stored in the preset storage space, and the sending the object information to a target display area determined based on the second position information in a device display image for display, comprises:
determining an image area corresponding to the identified object in the device display image based on the second position information, and determining a first ratio between an object size corresponding to the image area and a full size of the identified object;
if the first ratio is not less than a first preset threshold, determining a second ratio between an area of the image area and an entire image area of the device display image; and
if the second ratio is less than a second preset threshold, sending the object information of the identified object stored in the preset storage space to a target display area determined based on the image area in the device display image for display.

9. The information display method of claim 8, wherein the sending the object information of the identified object stored in the preset storage space to a target display area determined based on the image area in the device display image for display comprises:
determining a target display area having a fixed relative position relationship with the image area on the device display image, and sending the object information of the identified object stored in the preset storage space to the target display area for display.

10. An information display apparatus, which is applied to a device configured to display by superimposing virtual information with a real scene, comprising:
a pose acquisition module configured to acquire pose change information of the device between a first moment and a second moment;
a position determination module configured to determine second position information of the identified object at the second moment by using the pose change information and first position information of an identified object at the first moment stored in a preset storage space; and
an information display module configured to, if the second position information satisfies a preset condition, acquire object information of the identified object stored in the preset storage space, and send the object information to a target display area determined based on the second position information in a device display image for display.

11. An electronic device, comprising:
a memory for storing a computer program; and
a processor for executing the computer program to implement steps of the information display method of claim 1.

12. A computer-readable storage medium, which is used for storing a computer program, wherein when the computer program is executed by a processor, steps of the information display method of claim 1 are implemented.
